(19) United States
(12) Patent Application Publication
(10) Pub. No.: US 2005/0152276 A1
(43) Pub. Date: Jul. 14, 2005

(54) Method and system for sensing alarm in an asynchronous transfer mode network

(75) Inventors: Tae-Jin Kim, Seongnam-si (KR); Jin-Seon Kim, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/033,864

(22) Filed: Jan. 13, 2005

(30) Foreign Application Priority Data
Jan. 13, 2004 (KR) 2004-2470

(51) Int. Cl. H04L 12/26; H04J 3/14; H04J 1/16; H04L 1/00

(52) U.S. Cl. 370/241.1

(57) ABSTRACT

A system for sensing an alarm indicating a failure happening on a trunk in an Asynchronous Transfer Mode (ATM) network. In the system, upon failure to receive an alarm indicating a failure occurrence on the trunk, a base station controller (BSC) determines whether a Loss of Cell Delineation (LCD) alarm happens due to a failure to normally receive data through the trunk. A failure manager manages a failure according to a report on the LCD alarm, received from the BSC. A base station transceiver subsystem (BTS), if it perceives a failure has happened on the trunk, informs the failure manager of the occurrence of the LCD alarm.

### PRIORITY

This application claims the benefit under 35 U.S.C. §119(a) of an application entitled “Method and System for Sensing Alarm in an Asynchronous Transfer Mode Network” filed in the Korean Intellectual Property Office on Jan. 13, 2004 and assigned Serial No. 2004-2470, the entire contents of which are incorporated herein by reference.

### BACKGROUND OF THE INVENTION

1. Field of the Invention

The present invention relates generally to an operation and maintenance method and system in an Asynchronous Transfer Mode (ATM) network for a mobile communication system. In particular, the present invention relates to a method and system for sensing an alarm in a commercial network, which does not transmit an alarm on a trunk.

2. Description of the Related Art

Conventionally, in order to transmit data through a trunk, the data is assembled into a frame, and performance audit and maintenance information of each section is stored in the frame while the frame passes through several repeaters and multiplexers. For trunk maintenance, various signals are used, and failure signals detected from a framer by an end node include Loss Of Signal (LOS), Loss Of Frame (LOF), and Loss of Pointer (LOP) signals. As failure signals appear on a trunk, two types of maintenance signals, such as Alarm Indication Signal (AIS) and Remote Alarm Indication (RAI) signals, which are alarm indication signals, are used for detecting a transmission failure and indicating the position of the detected transmission failure.

Generally, when a failure happens in a trunk, the failure is sensed using AIS/RAI alarm signals carried by a framer as illustrated in FIG. 1. A process of transmitting AIS/RAI alarms through a trunk will now be described below with reference to FIG. 1.

FIG. 1 is a block diagram illustrating an alarm detection and signal through a trunk in a conventional ATM network. When a failure happens in a trunk with a signal transmitted in a specific direction, the trunk generates and transmits an AIS in a forward direction. Referring to FIG. 1, if a failure happens due to the cutoff of a link between a repeater-A 21 and a repeater-B 22, the repeater-A 21 generates and transmits an AIS to a base station controller (BSC) 10. Then the base station controller 10 perceives the failure through the AIS.

An end node receiving the AIS, for example, the base station controller 10, transmits an RAI signal in a backward direction every second. The RAI signal is transmitted to a base station transceiver subsystem (BTS) 30 via the repeater-A 21 and the repeater-B 22. Then the base station transceiver subsystem 30 perceives the failure through the received RAI.

However, in a commercial network developed from the Integrated Services Digital Network (ISDN), because data transmitted from different lines is multiplexed according to a time slot, even though a failure happens in a particular link where the data is received, repeaters cannot transmit AIS/RAI alarms due to the multiplexing. The cutoff of the AIS/RAI alarm transmission caused by the multiplexers will now be described below in more detail with reference to FIG. 2.

FIG. 2 is a block diagram illustrating the cutoff of an alarm transmission caused by the multiplexers in a conventional ISDN network. Referring to FIG. 2, in a conventional scheme, multiplexers should transmit alarms to end nodes because the link cutoff happens between a multiplexer-A 41 and a multiplexer-B 42. However, due to multiplexing, the multiplexer-A 41 does not transmit an AIS alarm to a base station controller 10. Therefore, the base station controller 10 can perceive a failure through a Loss of Cell Delineation (LCD) alarm, which exists only on a reception side. The base station controller 10 does not transmit an RAI alarm because it has not received an AIS alarm. As a result, the multiplexer-A 41 also does not transmit a RAI alarm in a backward direction. Therefore, a base station transceiver subsystem 30 cannot perceive a failure that has occurred on a trunk.

In the existing commercial network, not supporting the latest transmission standard, even though a failure happens on a trunk due to multiplexing, the transmission and reception end nodes fail to perceive the failure and continuously allocate a call to the corresponding link. Therefore, in terms of system operation, no trunk failure is indicated, yet call service is not normally achieved.

### SUMMARY OF THE INVENTION

It is, therefore, an object of the present invention to provide a method and apparatus for allowing an end node to sense an alarm by generating an alarm when a failure happens in a commercial network that multiplexes data before transmission, typically, in a mobile communication system.

It is another object of the present invention to provide a method and apparatus for sensing an alarm by regarding, as a failure, an LCD alarm detected in a transmission convergence (TC) sublayer, which is not affected by a commercial network, in a mobile communication system.

To achieve the above and other objects, there is provided a method for sensing an alarm indicating a failure that has occurred on a trunk in an Asynchronous Transfer Mode (ATM) network. The method comprises the steps of: indicating a failure has occurred on the trunk upon failure to receive an alarm, determining whether a Loss of Cell Delineation (LCD) alarm happens due to a failure to normally receive data through the trunk, and, if the LCD alarm happens, reporting the happening of the LCD alarm to a failure manager and a transmission end node, and, if the failure has been restored to a normal state through the report on the happening of the LCD alarm, sending an LCD alarm clear indication to the failure manager and the transmission end node to clear the LCD alarm.

To achieve the above and other objects, there is provided a system for sensing an alarm indicating a failure has occurred on a trunk in an Asynchronous Transfer Mode (ATM) network. The system comprises a base station controller (BSC) for, upon failure to receive an alarm indicating a failure has occurred on the trunk, determining whether a Loss of Cell Delineation (LCD) alarm happens due to a failure to normally receive data through the trunk, a failure manager for managing a failure according to a report on the LCD alarm, received from the BSC, and a base station transceiver subsystem (BTS) for, if it perceives happening of a failure on the trunk, informing the failure manager of happening of the LCD alarm.

### BRIEF DESCRIPTION OF THE DRAWINGS

The above and other objects, features and advantages of the present invention will become more apparent from the following detailed description when taken in conjunction with the accompanying drawings in which:

FIG. 1 is a block diagram illustrating alarm detection and signaling through a trunk in a conventional ATM network;

FIG. 2 is a block diagram illustrating the cutoff of an alarm transmission caused by the multiplexers in a conventional ISDN network;

FIG. 3 is a block diagram illustrating an alarm sensing apparatus in a mobile communication system according to an embodiment of the present invention; and

FIG. 4 is a message flow diagram illustrating a procedure for sensing an alarm in a mobile communication system according to an embodiment of the present invention.

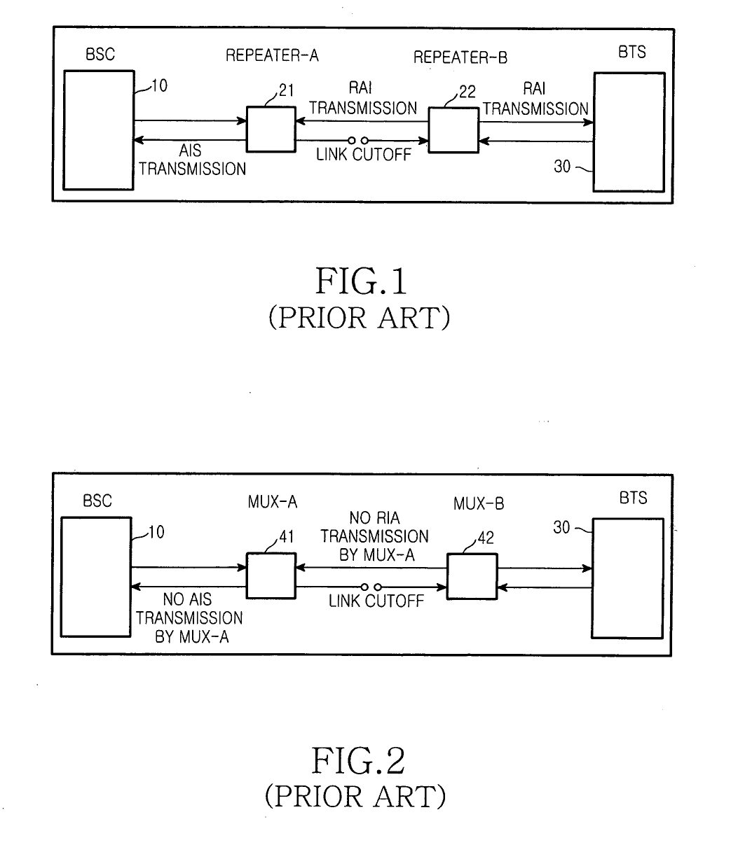

### DETAILED DESCRIPTION OF THE PREFERRED EMBODIMENTS

A preferred embodiment of the present invention will now be described in detail with reference to the annexed drawings. In the drawings, the same or similar elements are denoted by the same reference numerals even though they are depicted in different drawings. In the following description, a detailed description of known functions and configurations has been omitted for the sake of conciseness.

In an ATM protocol, AIS/RAI alarms are detected in a physical medium (PM) sublayer and can be affected by repeaters or multiplexers in a commercial network. Therefore, the embodiments of the present invention regard, as a failure, a Loss of Cell Delineation (LCD) alarm detected in a transmission convergence (TC) sublayer, which is not affected by the commercial network. The LCD alarm happens when a bit stream arriving through a physical medium cannot be distinguished on a per-ATM cell basis. If data cannot be transmitted due to a failure on a trunk, a reception end node fails in distinguishing data on a per-ATM cell basis, and senses the data distinguishment failure as an alarm.

Therefore, although a reception end node fails to receive an AIS alarm, it can perceive of the occurrence of a failure through an LCD alarm. In addition, embodiments of the present invention transmit a remote-LCD alarm, which is an information alarm to a transmission end node, so that the transmission end node receives the remote-LCD alarm instead of an RAI alarm and perceives the received remote-LCD alarm as a failure. In this way, an embodiment of the present invention senses a trunk failure in a transmission convergence sublayer and transmits the sensed failure to management entities in transmission and reception end nodes, thereby preventing unnecessary traffic transmission and maintaining stable system operation.

With reference to an accompanying drawing, a description will now be made of an alarm sensing apparatus for sensing an alarm in a commercial network according to an embodiment of the present invention. It will be assumed herein that the commercial network that cannot perceive AIS/RAI alarms is a CDMA2000 system.

The CDMA2000 system includes a base station system that wirelessly communicates with its mobile stations. The base station system includes a base station transceiver subsystem (BTS) that exchanges data with a mobile station or an upper layer, and a base station controller (BSC) that controls the base station transceiver subsystem.

A detailed description will now be made of an alarm sensing apparatus for sensing a failure happening on a physical line between the base station transceiver subsystem and the base station controller, and the processing of the sensed failure.

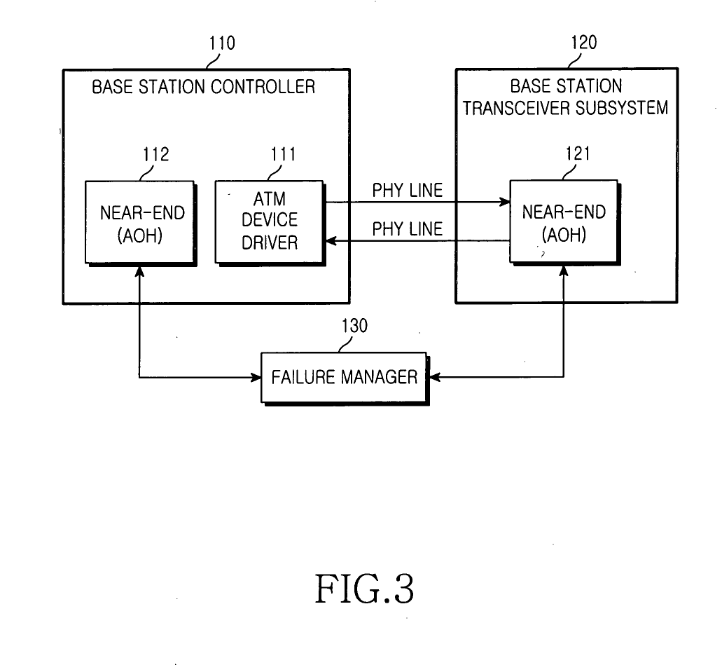

FIG. 3 is a block diagram illustrating an alarm sensing apparatus in a mobile communication system according to an embodiment of the present invention. A base station controller 110 and a base station transceiver subsystem 120 in a CDMA2000 system, illustrated in FIG. 3, refer to line interface boards, for example, AppleTalk Echo Protocol (AEP) and Bearer Independent Protocol (BIP) boards, included therein.

Referring to FIG. 3, the alarm sensing apparatus is divided into individual interface boards of the base station controller 110 and the base station transceiver subsystem 120, and a failure manager 130.

The base station controller 110 comprises a device driver 111 of an ATM transmission convergence (TC) sublayer, which detects and manages an alarm, and a near-end Ad-on-hold (AOH) 112 which takes charge of an operation and maintenance function on an ATM network. The base station transceiver subsystem 120 comprises a far-end AOH 121 that takes charge of an operation/maintenance function on the ATM network. The near-end AOH 112 in the base station controller 110 and the far-end AOH 121 in the base station transceiver subsystem 120 interwork with the failure manager 130 that manages all hardware and software alarms in the system.

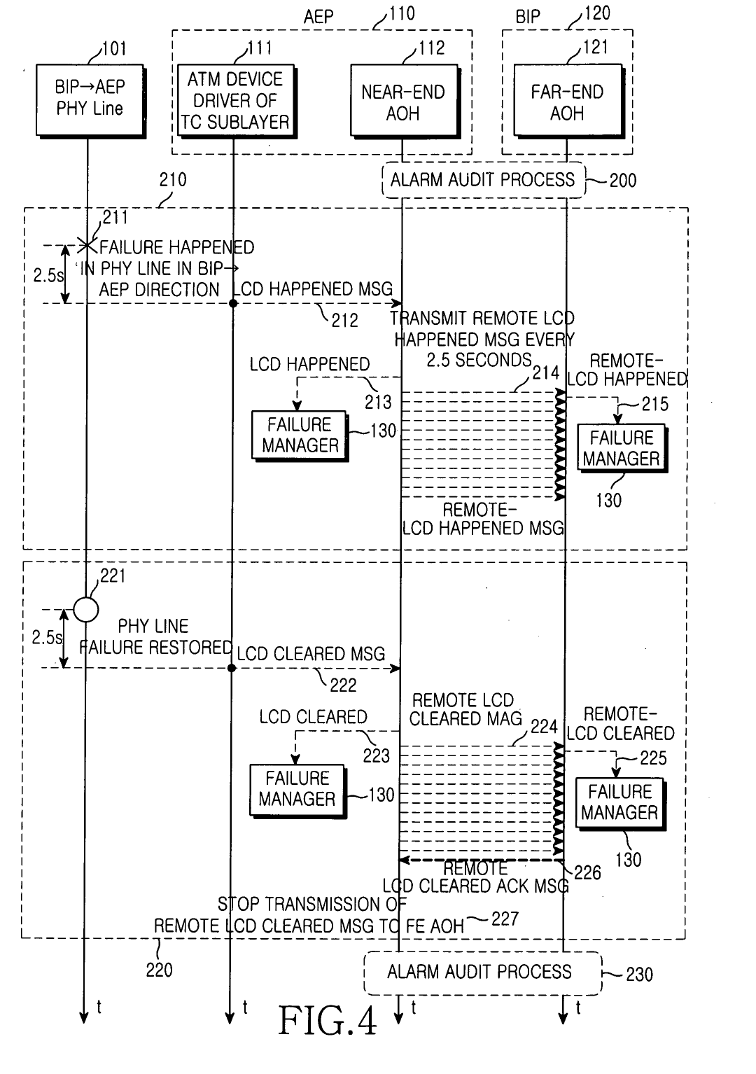

With reference to FIG. 4, a description will now be made of a procedure for sensing an alarm using the alarm sensing apparatus in an ATM network.

In the alarm sensing apparatus, the procedure for sensing an alarm can be divided into alarm audit processes 200 and 230, an alarm-happened process 210, and an alarm-cleared process 220.

FIG. 4 is a message flow diagram illustrating a procedure for sensing an alarm in a mobile communication system according to an embodiment of the present invention.

Referring to FIG. 4, the base station controller (or AEP board) 110 and the base station transceiver subsystem (or BIP board) 120 are initialized, the near-end AOH 112 and the far-end AOH 121 perform an alarm audit process 200. In the alarm audit process 200, the near-end AOH 112 and the far-end AOH 121 synchronize an alarm state maintained by the ATM device driver 111 of the transmission convergence (TC) sublayer with the failure manager 130. This process is performed in response to the process in which the near-end AOH 112 and the far-end AOH 121 are initialized and to a periodic request from the failure manager 130, and in this process, the near-end AOH 112 and the far-end AOH 121 analyze an alarm state of the current ATM device and report the analysis result to the failure manager 130. Here, the periodic request is made at preferably 2.5-second intervals.

While the alarm audit process 200 is being performed, if a failure happens on a physical line 101 during signal transmission from the base station transceiver subsystem 120 to the base station controller 110 in step 211, the ATM device driver 111 audits an LCD alarm because no data is received from the near-end AOH 112. At this moment, if an LCD alarm happens, the ATM device driver 111 detects, in step 212, the happening of an LCD alarm based on a state machine and transmits an LCD Happened Message to the near-end AOH 112.

In step 213, the near-end AOH 112 informs the failure manager 130 of the happening of an LCD alarm. In step 214, the near-end AOH 112 continuously transmits a Remote LCD Happened Message to the far-end AOH 121 at 2.5-second intervals until its own LCD alarm is cleared. In step 215, the far-end AOH 121 then transmits a remote-LCD alarm to the failure manager 130. That is, the far-end AOH 121 informs the failure manager 130 of receipt of an LCD alarm indicating that a failure has happened on the trunk. At this point, because a handshake cannot be used due to the cutoff of a link in a specific direction, the far-end AOH 121 continuously transmits a Remote LCD Happened message, which is a unidirectional message sent repeatedly in 2.5-second intervals until its own LCD alarm is cleared.

After sensing an alarm in this way and overcoming a failure on a failed part, the alarm sensing apparatus performs the alarm-cleared process 220.

If the ATM device driver 111 senses in step 221 that the failed physical line 101 has been restored to its normal state, the ATM device driver 111 detects, in step 222, clearance of the LCD alarm base on the state machine, and transmits an LCD Cleared Message to the near-end AOH 112.

In step 223, the near-end AOH 112 informs the failure manager 130 of the clearance of the LCD alarm. In step 224, the near-end AOH 112 continuously transmits a Remote LCD Cleared Message to the far-end AOH 121 every 2.5-second intervals until an acknowledgement (Ack) message is received.

In step 225, the far-end AOH 121 informs the failure manager 130 of the clearance of the LCD alarm. In step 226, the far-end AOH 121 transmits a Remote LCD Cleared Ack Message to the near-end AOH 112. Here, if a currently received remote-LCD alarm is identical to a previous remote-LCD, the far-end AOH 121 disregards the remote-LCD alarm. In step 227, the near-end AOH 112 stops transmission of a Remote LCD Cleared Message to the far-end (FE) AOH 121. At this point, because the link has been restored to its normal state, 2-way handshake is used. With the use of the 2-way handshake, if the near-end AOH 112 receives a Remote LCD Cleared Ack Message from the far-end AOH 121, the near-end AOH 112 no longer transmits the Remote LCD Cleared Message comprising clearance information. However, if the Remote LCD Cleared Ack Message is not received, the near-end AOH 112 continuously transmits the Remote LCD Cleared Message at 2.5-second intervals until the Remote LCD Cleared Ack Message is received.

After overcoming the failure and clearing the LCD alarm in this way, the near-end AOH 112 and the far-end AOH 121 performs again an alarm audit process 230.

As described above, because the embodiment of the present invention determines whether a failure has happened based on data carried by a physical medium sublayer, it may not be affected by a repeater that transparently transmits data from a transmission convergence sublayer. In addition, an embodiment of the present invention allows transmission and reception end nodes to perceive an LCD alarm detected in the transmission convergence sublayer as a failure, contributing to a stable system operation.

While the invention has been shown and described with reference to certain preferred embodiments thereof, it will be understood by those skilled in the art that various changes in form and details may be made therein without departing from the spirit and scope of the invention as defined by the appended claims.

1. A method for sensing an alarm indicating a failure happening on a trunk in an Asynchronous Transfer Mode (ATM) network, the method comprising the steps of:
(a) indicating, upon failure to receive an alarm, a failure has occurred on the trunk, determining whether a Loss of Cell Delineation (LCD) alarm happens due to a failure to normally receive data through the trunk;
(b) if the LCD alarm happens, reporting the happening of the LCD alarm to a failure manager and a transmission end node; and
(c) if the failure has been restored to a normal state through the report on the happening of the LCD alarm, sending an LCD alarm clear indication to the failure manager and the transmission end node to clear the LCD alarm.

2. The method of claim 1, wherein the step (b) comprises the steps of:
perceiving the occurrence of a failure as no data is received through a physical medium on the trunk;
if the LCD alarm happens due to the occurrence of the failure, reporting the happening of the LCD alarm to the failure manager; and
if the LCD alarm happens, receiving a remote LCD happened message including information indicating the happening of the LCD alarm.

3. The method of claim 2, wherein the remote LCD happened message is transmitted to the transmission end node at intervals of a predetermined time until the LCD alarm is cleared.

4. The method of claim 1, wherein the step (c) comprises the steps of:
perceiving non-occurrence of a failure as data is received through a physical medium on the trunk;
sending an LCD alarm clear indication to the failure manager due to the non-happening of the failure;
transmitting a remote LCD cleared message comprising information indicating clearance of the LCD alarm to the transmission end node due to the non-happening of the failure; and
upon receiving an acknowledgement for the clearance of the LCD alarm from a base station transceiver subsystem, stopping transmission of the remote LCD cleared message.

5. The method of claim 4, wherein the remote LCD cleared message is transmitted to the transmission end node at intervals of a predetermined time until an acknowledgement for the clearance of the LCD alarm is received.

6. A system for sensing an alarm indicating a failure has happened on a trunk in an Asynchronous Transfer Mode (ATM) network, comprising;
a base station controller (BSC) for, upon failure to receive an alarm indicating a failure has happened on the trunk, determining whether a Loss of Cell Delineation (LCD) alarm happens due to a failure to normally receive data through the trunk;
a failure manager for managing a failure according to a report on the LCD alarm, received from the BSC; and
a base station transceiver subsystem (BTS) for, if it perceives happening of a failure on the trunk, informing the failure manager of happening of the LCD alarm.

7. The system of claim 6, wherein the BSC perceivers the non-happening of a failure as data is received through a physical medium on the trunk, and sends an LCD alarm clear indication to the failure manager and the BTS.

8. The system of claim 6, wherein the BSC comprises:
a device driver for perceiving the happening of a failure as no data is received through a physical medium on the trunk, and if the LCD alarm happens, transmitting a remote LCD happened message including information indicating the happening of the LCD alarm; and
a near end node for reporting the happening of the LCD alarm to the failure manager upon receiving the remote LCD happened message, and transmitting a remote LCD happened message to the BTS.

9. The system of claim 8, wherein the remote LCD happened message is transmitted to the BTS at intervals of a predetermined time until the LCD alarm is cleared.

10. The system of claim 8, wherein the device driver perceives the non-happening of a failure as data is normally received through a physical medium on the trunk, and transmits a remote LCD cleared message to the near end node.

11. The system of claim 8, wherein the near end node transmits a remote LCD cleared message to the BTS if data is normally received through a physical medium on the trunk, and stops transmission of the remote LCD cleared message if an acknowledgement for the remote LCD cleared message is received from the BTS.

12. The system of claim 11, wherein the remote LCD cleared message is transmitted to the BTS at intervals of a predetermined time until an acknowledgement for the remote LCD cleared message is received.
